(19) United States
(12) Patent Application Publication
(10) Pub. No.: US 2005/0213172 A1
(43) Pub. Date: Sep. 29, 2005

(54) Printer

(75) Inventor: Hitoshi Funaki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/087,228

(22) Filed: Mar. 23, 2005

(30) Foreign Application Priority Data
Mar. 29, 2004 (JP) 2004-094846

(51) Int. Cl. G06F 15/00

(52) U.S. Cl. 358/498; 358/1.2

(57) ABSTRACT

In a printer having a printing means for printing a desired image on a recording paper, a switching means for switching a print condition of the printing means corresponding to the type of the recording paper is arranged. In a vicinity of a storage unit of the paper tray, a switching knob for switching printing in a full-page layout on the entire surface of the recording paper or in a divided layout on the recording paper divided into a predetermined number of pieces is arranged. By mounting the paper tray in a tray mounting portion of the printer, the print condition is switched corresponding to the type of the recording paper used, and by operating the switching means with the switching knob, the switching is performed to print in the divided layout or in the full-page layout.

### BACKGROUND OF THE INVENTION

1. Field of the Invention

The present invention relates to a paper tray and a printer using the paper tray, and more specifically relates to a paper tray which can operate a switching means capable of switching the print condition of a printer according to the type of recording paper stored in a paper storage unit, and a printer using the paper tray.

2. Description of the Related Art

In a conventional paper tray 21 used in a printer, as shown in FIG. 5, a longitudinal groove 22 is formed with a predetermined width and length, a tail guide 23 is movable in the direction of an arrow C along the longitudinal groove 22. In the paper tray 21, for example, a number of recording papers (not shown), such as photographic printing papers, having a predetermined size is stored, and the longitudinal position of the recording paper is determined by the tail guide 23.

Also, when the tail guide 23 moves in the direction of the arrow C, a switch operating body 30 is operated through a link (not shown) connected to the tail guide. The switch operating body 30 is designed to operate any one of a plurality of switches (not shown).

Further, in the paper tray 21, transverse grooves 24 and 25 are formed with a predetermined width and length, and a pair of guides 26 and 27 formed roughly in a “U” shape along the transverse grooves 24 and 25 is movably arranged in the direction of an arrow D. Also, the transverse position of the recording paper stored in the paper tray 21 can be determined by the pair of guides 26 and 27.

Further, a substantially fan-shaped lever 28 and a slider 29 are arranged to be movable in conjunction with the pair of guides 24 and 25 which moves corresponding to type of recording paper used, and if the pair of guides 24 and 25 moves in the direction of the arrow D, the slider 29 slides in the longitudinal direction through the lever 28, to operate the switch operating body 30, so that any one of the plurality of switches can be operated.

Additionally, by the combination of ON/OFF operation of the plurality of switches, the size of the recording paper can be detected.

Such a conventional paper tray 21 is designed to send detected information on the size of the recording paper to a printer (not shown), and the print condition is switched according to the size of the recording paper, so that images like a picture can be printed on the recording paper.
[PATENT DOCUMENT 1] JAPANESE UNEXAMINED PATENT APPLICATION PUBLICATION NO. 08-119462
[PATENT DOCUMENT 2] JAPANESE UNEXAMINED PATENT APPLICATION PUBLICATION NO. 05-034525

Meanwhile, the conventional paper tray 21 can detect the size of the recording paper. However, a case in which the recording paper stored in the paper tray 21 is a seal paper, whether the seal paper is, for example, a seal paper divided into eight pieces and pasted on a mount or a full-size seal paper having the same size as the mount and pasted on the mount, cannot be detected.

Accordingly, in a printer using the conventional paper tray 21, in a case of printing on the seal paper in a divided layout, since whether to perform printing in a divided layout or in a full-page layout is set in a digital camera or a personal computer that stores image information, the operation of printing on the seal paper is often troublesome.

Furthermore, in a case in which picture images photographed by a digital camera mounted in a cellular phone using infrared communication is dividedly printed on the seal paper, because the cellular phone cannot set the printing in a divided layout, in addition to a switch for detecting the size of the recording paper, a switch for setting the printing in a divided layout on the seal paper must be arranged in the printer. As a result, the number of parts increases, which consequently increases the manufacturing cost.

### SUMMARY OF THE INVENTION

An advantage of the present invention is that it provides a paper tray which makes it possible to print on a seal paper in a divided layout and a printer utilizing the paper tray, by using a switch for detecting types of recording papers.

As a first means to accomplish the object, the present invention provides a paper tray including a recording paper having a predetermined size, and a paper storage unit capable of storing a plurality of recording papers. A switching means, capable of switching a print condition of the printing means corresponding to a type of the recording paper, is arranged in a printer having a printing means capable of printing a desired image on the recording paper, and a switching knob, which is capable of selecting printing in a full-page layout on an entire surface of the recording paper stored or in a divided layout on the recording paper divided into a predetermined number of pieces, is arranged in the vicinity of the storage unit. A paper tray is mounted in a tray mounting portion of the printer to switch the print condition corresponding to the type of the recording paper, and the switching means can be operated by the switching knob to print in the divided layout or in the full-page layout. Accordingly, by the switching means capable of switching the print condition of the printing means of the printer corresponding to type of the recording paper, it is easy to select whether to print an image photographed by a digital camera mounted in a cellular phone in a full-page layout or in a divided layout on the recording paper. Furthermore, since one switching means is able to switch the print condition corresponding to the type of the recording paper and select printing in the full-page layout or in a divided layout, the number of parts can be decreased.

Further, as a second means to accomplish the object, a seal paper which is pasted on a mount and peelable from the mount can be stored in the paper storage unit, the seal paper is a seal paper divided into a predetermined number of pieces and pasted on the mount or is a full-size seal paper having roughly the same size as the mount and pasted on an entire surface of the mount, and by changing a position of the switching knob, the switching is performed to print in the divided layout on the each piece of the seal paper divided into a predetermined number of pieces or to print in the full-page layout on an entire surface of the seal paper. Accordingly, it is easy to select printing in a full-page layout or in a divided layout on the seal paper.

Moreover, as a third means to accomplish the object, the switching means is composed of a switch unit having a plurality of operating portions and switch circuits corresponding to the plurality of operating portions, and the print condition of the printing means can be switched by operating the operating portions and switching the switch circuits.

Furthermore, as a fourth means to accomplish the object, the operating portions and the switch circuits of the switch unit are three, respectively, and the switching is performed to print in the divided layout or in the full-page layout by operating at least one of the plurality of the operating portions with the switching knob.

Furthermore, as a fifth means to accomplish the object, the present invention provides a printer including a printing means for printing a desired image on the recording paper, a paper tray for storing the recording paper prior to printing, and a tray mounting portion for mounting the paper tray therein. The switching means for switching a print condition of the printing means corresponding to a type of the recording paper is arranged in the tray mounting portion. The switching means can be operated by the paper tray mounted in the tray mounting portion. A switching knob for switching printing in the full-page layout on an entire surface of the recording paper or in the divided layout on the recording paper divided into a predetermined number of pieces is arranged in the paper tray.

Furthermore, as a sixth means to accomplish the object, the switching means is composed of a switch unit having a plurality of operating portions and switch circuits corresponding to the plurality of operating portions, and the switching is performed to print in a divided layout or in a full-page layout by operating at least one of the plurality of operating portions with the switching knob.

### BRIEF DESCRIPTION OF THE DRAWINGS

FIG. 1 is a plan view of a paper tray according to the present invention;

FIG. 2 is a cross-sectional view taken along a line 2-2 of FIG. 1;

FIG. 3 is an enlarged view of a main part explaining the operation of a switching knob according to the present invention;

FIG. 4 is another enlarged view of the main part explaining the operation of the switching knob according to the present invention; and

FIG. 5 is a perspective view of a conventional paper tray.

### DESCRIPTION OF THE PREFERRED EMBODIMENTS

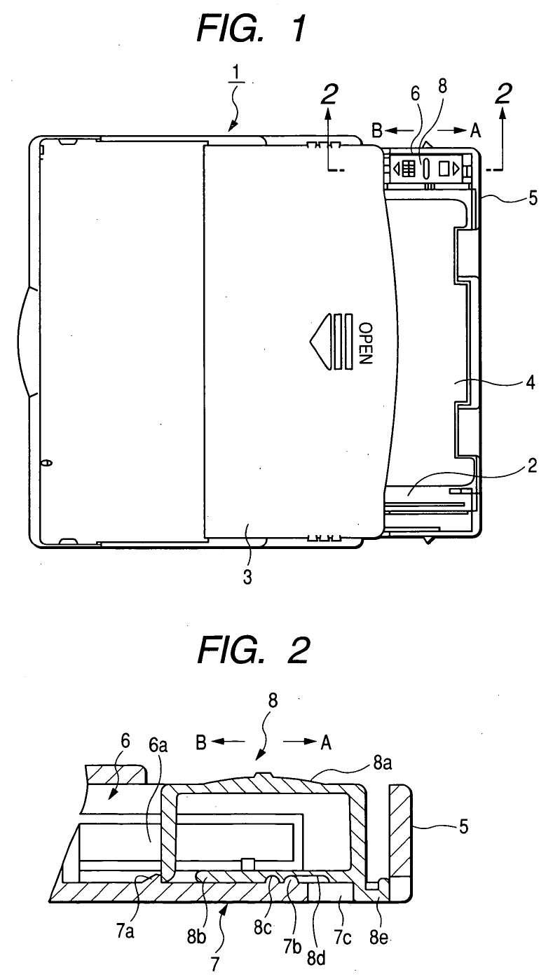

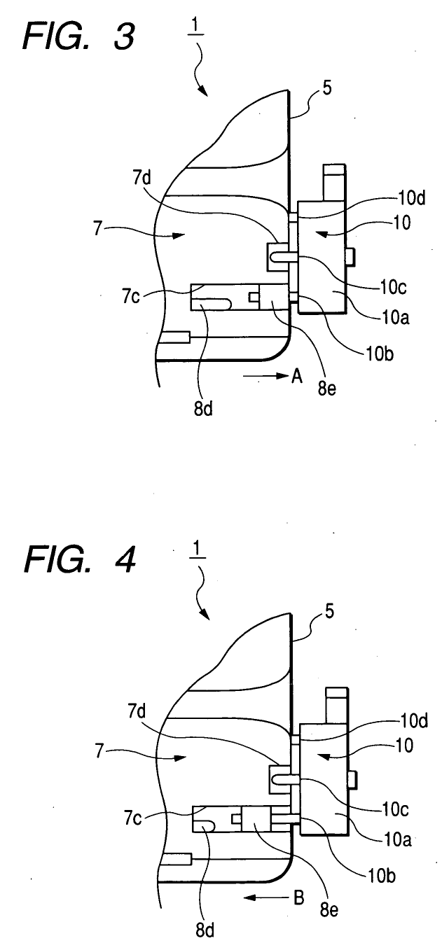

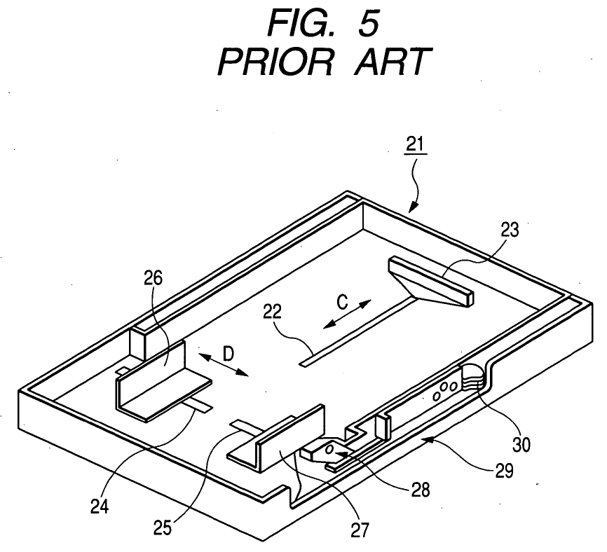

Hereinafter, preferred embodiments of the present invention will be described with reference to the accompanying drawings. FIG. 1 is a plan view of a paper tray according to the present invention, FIG. 2 is a cross-sectional view taken along a line 2-2 shown in FIG. 1, and FIGS. 3 and 4 are enlarged views of a main part explaining operation of a switching knob according to the present invention.

First, according to a first embodiment of the present invention, a paper tray 1, as shown in FIG. 1, is formed into a substantially rectangular shape by molding a resin material. Also, a paper storage unit 2 which can accommodate recording papers (not shown) having a predetermined size therein is formed in the paper tray 1, and a cover member 3 is arranged above the paper storage unit 2 to open and close an upper portion of the paper tray 2.

The cover member 3 shown in FIG. 1 is in a state in which a paper discharge side (right side in the drawing) is opened. In this state, by mounting the cover member to a tray mounting portion (not shown) of a printer (not shown), which will be described later, recording papers stored inside can be fed to a printing means of the printer.

Further, the paper tray 1 has a predetermined dimension, but the paper storage unit 2 has a variable dimension to correspond to the sizes of recording papers.

Also, a pressure plate 4 capable of elastically contacting a paper feed roller (not shown) of the printer by pushing up the recording papers stored in the paper storage unit 2 is arranged at a bottom of the paper storage unit 2.

Further, in the paper tray 1, a front wall 5 is formed at a front end (right side in FIG. 1) of the paper storage unit 2, and as shown in FIG. 2, a guide unit 6 having a hollow portion 6a therein is formed at one side wall of the paper storage unit 2.

In a bottom wall 7 of the guide unit 6, a hooked stopper portion 7a and a circular-arc convex portion 7b are formed.

Further, in the bottom wall 7, an open groove 7c with a predetermined dimension in width is formed, and a lower portion of the front wall 5 is partially opened by the open groove 7c.

Further, in the hollow portion 6a of the guide unit 6, a switching knob 8 having a substantially parallelepiped outer appearance and a hollow inside is arranged, and the switching knob 8 is slidable in directions of the arrows A and B in the hollow portion 6a.

Further, as for the switching knob 8 located inside the hollow portion 6a, its top surface 8a is exposed and a concave portion 8c is formed in a circular shape with a predetermined depth in a bottom plate 8b inside.

Further, by sliding the switching knob 8 in the directions of the arrows A and B, a concave portion 8c engages or disengages the convex portion 7b, generating a click sense of touch.

Further, a groove portion 8d having a predetermined depth, in which the switching knob 8 is slidable in the directions of the arrows A and B, is formed in the bottom plate 8b on the right side of FIG. 2 adjacent to the concave portion 8c with the convex portion 7b being engaged therewith. Further, an SW operating portion 8e is formed to protrude toward the open groove 7c from the right end (in the drawing) of the bottom plate 8b.

Further, when the switching knob 8 is slid in the direction of the arrow A, the right end face (in the drawing) of the SW operating portion 8e is substantially made flush with the front face of the front wall 5.

In a the printer utilizing the paper tray 1 of the present invention constructed as above, a printing means composed of a print head, a tray mounting portion capable of mounting the paper tray 1 therein, and a switching means 10 capable of switching the print condition of the printing means corresponding to a type of recording paper are arranged, though not shown.

The switching means 10, as shown FIGS. 3 and 4, is attached to a portion of the printer facing a portion of the front wall 5 in which the open groove 7c of the paper tray 1 to be mounted in the tray mounting portion is formed.

Further, the switching means 10 is composed of, for example, a switch unit in which three push button switches are unified parallel to the front wall 5.

In the switching means 10, a case 10a, first to third rod-shaped operating portions 10b, 10c and 10d protruding from the case 10a, and switch circuits inside the case 10a corresponding to the first to third operating portions 10b, 10c and 10d are formed. The switch circuits inside the case 10a are designed to be switched when the first to third operating portions 10b, 10c and 10d are pressingly operated.

Furthermore, by switching a switch circuit corresponding to any one of the first to third operating portions 10b, 10c and 10d, the print condition of the printing means can be changed.

Furthermore, FIGS. 3 and 4 are views showing the paper tray in a state being mounted in the printer, as seen from the back side, in which the SW operating portion 8e of the switching knob 8 is located in the open groove 7c of the bottom wall 7. A groove portion 8d formed at the bottom plate 8b of the switching knob 8 can be seen from the open groove 7c.

By describing the operation of printing recording papers by the printer utilizing the paper tray of the present invention, the recording paper is described, for example, as a paper having the same size as a cash card. As for the paper tray 1 storing the recording paper the same size as the cash card, as shown in FIG. 3, when the switching knob 8 is slid in the direction of the arrow A, the right end face of the SW operating portion 8e is made substantially flush with the end face of the front wall 5.

At this time, the movement of the switching knob 8 is controlled by the engagement of the concave portion 8c with the convex portion 7b in the directions of the arrows A and B, and a click sense of touch is generated.

When the paper tray 1 is mounted in the tray mounting portion of the printer, as for the switching means 10, the first operating portion 10b is pressed by the SW operating portion 8e and the first switch circuit corresponding to the first operating portion 10b is switched.

Furthermore, the second operating portion 10c adjacent to the first operating portion 10b is not pressed since it is located in a relief groove. Therefore, the second switch circuit corresponding to the second operating portion 10c is not switched. Further, the third operating portion 10d adjacent to the second operating portion 10c is pressed by the front wall 5 of the paper tray 1, to switch the third switch circuit corresponding to the third operating portion 10d.

Like this, the first and third operating portion 10b and 10d are pressed to switch the first and third switch circuits 10b and 10d, and thereby the condition of the printing means of the printer is switched to the print condition corresponding to the recording paper having the size of a card. Accordingly, full-size images like pictures can be printed on the recording paper having the size of a card.

Furthermore, in a case of printing on the recording paper having a size of a photograph, as for the paper tray storing recording papers having the size of a photograph, for example, the switching knob 8 is eliminated, and thus the open groove 7c is removed, and the relief groove 7d is formed opposite to the third operating portion 10d, which is not shown.

When such a paper tray is mounted in the tray mounting portion of the printer, the first and second switch circuits are switched as the first and second operating portions 10b and 10c are pressed by the front wall 5, but the third switch circuit is not switched since the third operating portion 10d is located in the relief groove.

By this construction, a state that the paper tray 1 accommodating the recording papers having the size of a photograph is mounted in the tray mounting portion is detected, and the print condition of the printing means is switched corresponding to the recording paper having the size of a photograph. Thus, images like photographs can be printed on the recording paper having the size of a photograph.

Namely, as for the switching means 10 according to the present invention, when the paper tray 1 is mounted in the tray mounting portion of the printer, the type of the recording paper stored in the paper storage unit 2 is detected by pressing the front portions of the first to third operating portions 10b to 10d or any one of the first to third operating portions 10b to 10d with the front wall 5, the print condition of the printing means is switched corresponding to the type of the recording paper, and images like photographs can be printed on the recording paper.

Furthermore, in the print operation of a case in which the recording paper stored in the paper tray 1 is a seal paper having the size of a card, the seal paper (not shown) is pasted on a mount having roughly the same size as a card with glue, which is peelable from the mount.

The seal paper is, for example, a seal paper divided into eight pieces and pasted on a mount or a full-size paper having the same size as the mount and pasted on an entire surface of the mount.

Further, in a case in which a picture image photographed by a digital camera mounted in a cellular phone (not shown) using infrared communication is, for example, dividedly printed on the seal paper divided into eight pieces, as shown in FIG. 4, the switching knob 8 is slid in the direction of the arrow.

Then, as shown in FIG. 2, when the concave portion 8c of the switching knob 8 engaged with the convex portion 7b of the bottom wall 7 disengages, a click sense of touch is generated, the switching knob 8 abuts the stopper portion 7a and it stops sliding in the direction of the arrow B. Simultaneously, the open groove 7c at the lower portion of the front wall 5 is opened.

If such a paper tray 1 is mounted in the tray mounting portion of the printer, the SW operating portion 8e is separated from the first operating portion 10b. Therefore, since the first operating portion 10b is not pressed, the first switch circuit corresponding to the first operating portion 10b is not switched. Further, since the second operating portion 10c is located in the relief groove 7d, the second switch circuit is not switched. Further, since the third operating portion 10d is pressed by the front wall 5, the third switch circuit is switched.

By this construction, when the recording paper stored in the paper storage unit 2 is detected as the seal paper divided into eight pieces, the print condition of the printing means is switched corresponding to the seal paper divided into eight pieces, and images like photographs can be printed on the seal paper divided into eight pieces in a divided layout.

Furthermore, in a case in which the seal paper is of a full size which is not divided, by the same operation as printing on the recording paper having the size of a card in FIG. 3, a full-size seal paper which is not divided can be printed in a full-page layout.

In addition, although the embodiment of the present invention has been described about a switch unit having a combination of a plurality of switches as the switching means 10, a plurality of light emitting elements or light receiving elements may be arranged in the printer, or a plurality of light receiving elements or light emitting elements may be arranged in the paper tray.

1. A paper tray comprising:
a recording paper having a predetermined size;
a paper storage unit capable of storing a plurality of recording papers;
a switching means arranged in a printer having a printing means capable of printing a desired image on the recording paper, the switching means being capable of switching a print condition of the printing means corresponding to a type of the recording paper;
a switching knob arranged in a vicinity of the storage unit, which is capable of selecting printing in a full-page layout on an entire surface of the recording paper or to print in a divided layout on the recording paper divided into a predetermined number of pieces; and
a paper tray mounted in a tray mounting portion of the printer to switch the print condition corresponding to the type of the recording paper, and the switching means can be operated by the switching knob to print in the divided layout or in the full-page layout.

2. A paper tray according to claim 1,
wherein a seal paper which is pasted on a mount and peelable from the mount can be stored in the paper storage unit, the seal paper is a seal paper divided into a predetermined number of pieces and pasted on the mount or is a full-size seal paper having roughly the same size as the mount and pasted on an entire surface of the mount, and by changing the position of the switching knob, the switching is performed to print in the divided layout on each piece of the seal paper divided into a predetermined number of pieces or to print in the full-page layout on the entire surface of the seal paper.

3. A paper tray according to claim 2,
wherein the switching means is composed of a switch unit having a plurality of operating portions and switch circuits corresponding to the plurality of operating portions, and the print condition of the printing means can be switched by operating the operating portions and switching the switch circuits.

4. A paper tray according to claim 3,
wherein the operating portions and switch circuits of the switch unit are three, respectively, and the switching is performed to print in the divided layout or in the full-page layout by operating at least one of the plurality of operating portions with the switching knob.

5. A printer comprising:
a printing means for printing a desired image on a recording paper;
a paper tray for storing the recording paper; and
a tray mounting portion for mounting the paper tray therein,
wherein a switching means for switching a print condition of the printing means corresponding to a type of the recording paper is arranged in the tray mounting portion, the switching means being capable of being operated by the paper tray mounted in the tray mounting portion, and
a switching knob for switching printing in a full-page layout on an entire surface of the recording paper or in a divided layout on the recording paper divided into a predetermined number of pieces is arranged in the paper tray.

6. A printer according to claim 5,
wherein the switching means is composed of a switch unit having a plurality of operating portions and switch circuits corresponding to the plurality of operating portions, and the switching is performed to print in a divided layout or in a full-page layout by operating at least one of the plurality of operating portions with the switching knob.
